(19) United States
(12) Patent Application Publication
(10) Pub. No.: US 2010/0289630 A1
(43) Pub. Date: Nov. 18, 2010

(54) WINDOW GLASS BREAKAGE DETECTOR

(75) Inventors: Tsuneo Suzuki, Kariya-shi (JP); Mitsugu Kobayashi, Kariya-shi (JP)

Correspondence Address: GREENBLUM & BERNSTEIN, P.L.C., 1950 ROLAND CLARKE PLACE, RESTON, VA, 20191, US

(73) Assignee: KABUSHIKI KAISHA TOYOTA JIDOSHOKKI, Aichi-ken (JP)

(21) Appl. No.: 12/812,971

(22) PCT Filed: Dec. 22, 2008
(86) PCT No.: PCT/JP2008/073336

§ 371 Date: Jul. 15, 2010

(30) Foreign Application Priority Data
Feb. 25, 2008 (JP) 2008-043402

(51) Int. Cl. B60R 25/10

(52) U.S. Cl. 340/426.1

(57) ABSTRACT

A clip is used for detecting breakage of an openable window glass. The clip clips a window glass that selectively opens or closes an opening of a vehicle at an end of the window glass, and breaks apart the end of the window glass following breakage of the window glass. The clip includes a first member and a second member opposing each other that are formed by folding a steel plate for making a leaf spring. The first member and the second member contact the window glass disposed therebetween at offset positions on the window glass in directions to approach each other. Accordingly, detection of the breakage of the window glass is ensured even when the entire window glass is not broken apart following the breakage of the window glass.

### TECHNICAL FIELD

The present invention relates to a window glass breakage detector.

### BACKGROUND

Patent Document 1 discloses an anti-theft system for detecting breakage of window glass of a vehicle. As illustrated in FIG. 1, in this system, a compression coil spring 220 is provided to urge a carrier plate 211, which supports a window glass 200, of a cable-type window regulator 210 in the direction to close the window glass 200 when the window glass 200 is situated in a fully-closed position where a window opening is closed. When the window glass 200 is broken, restriction between a stopper pin 205 provided on the window glass 200 and an engaging portion 206 on the vehicle is released and the compression coil spring 220 urges the carrier plate 211 to move to a further advanced position in the direction to close the window glass 200 than the fully-closed position of the window glass 200. A limit switch 230 detects this, and thus detects breakage of the window glass 200.

Generally, hardened glass is used for the window glass 200. When an impact is applied to the window glass, the window glass breaks into pieces, but sometimes a part of the window glass remains unshattered. In particular, when the window glass 200 remains unshattered in the portion near the carrier plate 211, it is possible that the carrier plate 211 does not move to the further closed position, and breakage of the window glass 200 may not be detected.

### Patent Document 1: Japanese Laid-Open Patent Publication 11-321564

### SUMMARY OF THE INVENTION

It is an objective of the present invention to provide a window glass breakage detector that ensures detection of window glass breakage even when the window glass remains partly unbroken.

In one aspect of the invention, a window glass breakage detector is provided. The detector is attached to a window glass of a vehicle. Breakage of the window glass is detected by breaking at least a part of the window glass apart following the breakage of the window glass. The detector biases a surface of the window glass by elasticity of the detector in opposite directions, in contact with the surface of the window glass at offset positions on the window glass.

According to this configuration, when the window glass is broken, the strength of the window glass is deteriorated to cause the detector to break a part of the window glass into pieces so that breakage of the window glass can be detected. Thus, even when the window glass is not broken apart perfectly in the breakage of the window glass, detection of the breakage of the window glass is ensured.

In addition, the detector biases the glass surface of the window glass in opposite directions by its elasticity, making contact with the window glass at different points on the surfaces of the window glass. This facilitates breaking the window glass apart after breakage of the glass window. Thus, detection of breakage of the window glass is ensured.

In another aspect of the present invention, a window glass breakage detector is provided. The detector clips to a window glass that selectively opens or closes an opening of a vehicle at an end of the window glass. Breakage of the window glass is detected by breaking at least a part of the window glass apart following the breakage of the window glass, wherein the detector includes a first member and a second member that oppose each other. The first member and the second member are formed by folding a steel plate for making a leaf spring. The first member and the second member are biased in a direction to approach each other, in contact with a surface of the window glass disposed between the first member and the second member at offset positions on the window glass.

According to this configuration, when the window glass is broken, the strength of the window glass is deteriorated to cause the detector to break the end of the window glass into pieces by clamping force thereof so that breakage of the window glass can be detected. Thus, even when the window glass is not broken apart perfectly in the breakage of the window glass, detection of the breakage of the window glass is ensured. In addition, breakage of the window glass can be detected when the window glass is not in a fully-closed position.

The first member and the second member oppose each other and are biased in a direction to approach each other with the window glass 5 interposed therebetween. Further, forces are applied to the window glass at different points on the front and rear surfaces. Thus, after breakage of the window glass, the end of the window glass can be broken apart. Thus, detection of breakage of the window glass is ensured.

In one embodiment, the detector further comprises a folded portion that connects the first member with the second member. The folded portion is folded twice. The width of the second folded portion is narrower than the thickness of the window glass, and the end of the window glass contacts the first folded portion. According to this configuration, the end of the window glass can be reliably clamped by opposing sites of the detector formed by folding a steel plate for a leaf spring.

In another embodiment, the contact portions of the first member with the window glass are at two positions separated from one another so that the contact portion of the second member with the window glass is located between the two positions. A portion of the first member that faces the window glass including the contact portions of the first member with the window glass surrounds the contact portion of the second member with the window glass. According to this configuration, the window glass is pressed by the detector in a condition wherein the first member contacts the window glass around the contact portion of the second member with the window glass. Thus, breakage of the end of the window glass is facilitated to ensure falling of the detector.

In another embodiment, at least one of the first member and the second member contacts the window glass at protrusions.

According to this configuration, the window glass can be broken apart with less force.

In another embodiment, the window glass selectively opens or closes an opening of a vehicle. According to this configuration, breakage of the window glass can be detected even when the window glass does not take a fully-closed position.

In another embodiment, the detector includes a biasing arm and a pair of contact portions connected to the biasing arm, wherein the pair of contact portions are biased in opposite directions from each other with respect to the surface of the window glass on one side of the window glass, and are in contact with the surface of the window glass at the offset portions on the window glass.

In another embodiment, the window glass includes a through-hole, wherein the detector clamps the window glass on both sides of the window glass through the through-hole, wherein the detector biases a first surface of the window glass and a second surface of the window glass that opposes the first surface in opposite directions at positions spaced apart from the through-hole at different distances.

### BRIEF DESCRIPTION OF DRAWINGS

FIG. 1 is a front view illustrating a prior art detection system;

FIG. 2 is an exploded perspective view of a right front door in an automobile:

FIG. 3 is a schematic front view of the right front door in the automobile;

FIG. 4 is a longitudinal cross-sectional view taken along the line 4-4 of FIG. 3;

FIG. 5 is a perspective view of a break detection system for an openable window glass;

FIG. 6A is a front view of a clip;

FIG. 6B is a cross-sectional view taken along the line 6B-6B of FIG. 6A;

FIG. 6C is a longitudinal cross-sectional view taken along the line 6C-6C of FIG. 6A;

FIG. 7A is a front view of a break detection system for an openable window glass;

FIG. 7B is a longitudinal cross-sectional view taken along the line 7B-7B of FIG. 7A;

FIG. 8A is a front view of a break detection system for an openable window glass;

FIG. 8B is a longitudinal cross-sectional view taken along the line 8B-8B of FIG. 8A;

FIG. 9A is a front view of a break detection system for an openable window glass;

FIG. 9B is a longitudinal cross-sectional view taken along the line 9B-9B of FIG. 9A;

FIG. 10A is a front view of a breakage detection system for an openable window glass;

FIG. 10B is a longitudinal cross-sectional view taken along the line 10B-10B of FIG. 10A;

FIG. 11 is a graph of output characteristics of respective magnetic sensors;

FIG. 12 is a graph of summed output characteristic of the magnetic sensors;

FIG. 13 is a perspective view of a breakage detection system for an openable window glass according to a second embodiment;

FIG. 14 is a perspective view of the breakage detection system for an openable window glass when a window glass is broken;

FIG. 15A is a schematic view illustrating a situation before a detector is attached to a window glass;

FIG. 15B is a schematic view illustrating a situation when the detector is attached to the window glass;

FIG. 15C is a schematic view illustrating a situation when the window glass is broken;

FIG. 16 is a perspective view of a breakage detection system for an openable window glass according to a third embodiment;

FIG. 17A is a front view of the detector;

FIG. 17B is a plan view of the detector;

FIG. 17C is a side view of the detector;

FIG. 17D is a longitudinal cross-sectional view of the detector taken along the line 17D-17D of FIG. 17A;

FIG. 18A is a cross-sectional view taken along the line 18A-18A of FIG. 17A;

FIG. 18B is a cross-sectional view taken along the line 18B-18B of FIG. 17A;

FIG. 19A is a front view of the detector;

FIG. 19B is a plan view of the detector;

FIG. 19C is a side view of the detector;

FIG. 19D is a longitudinal cross-sectional view taken along the line 19D-19D of FIG. 19A;

FIG. 20A is a front view of the detector;

FIG. 20B is a plan view of the detector;

FIG. 20C is a side view of the detector;

FIG. 20D is a longitudinal cross-sectional view taken along the line 20D-20D of FIG. 20A;

FIG. 21A is a cross-sectional view taken along the line 21A-21A of FIG. 20A;

FIG. 21B is a cross-sectional view taken along the line 21B-21B of FIG. 20A;

FIG. 22A is a front view of a detector of a breakage detection system for an openable window glass according to a fourth embodiment;

FIG. 22B is a cross-sectional view taken along the line 22B-22B of FIG. 22A;

FIG. 23 is a cross-sectional exploded view of the detector;

FIG. 24A is a front view of the detector;

FIG. 24B is a cross-sectional view taken along the line 24B-24B of FIG. 24A;

FIG. 25A is a front view of the detector; and

FIG. 25B is a cross-sectional view taken along the line 25B-25B of FIG. 25A.

### DETAILED DESCRIPTION OF THE PREFERRED EMBODIMENTS

A first embodiment of the present invention will be described with reference to the drawings. Hereinafter, “front” and “rear” refer to front and rear in the moving direction of a vehicle, and “inside” and “outside” refer to the inside and outside of a vehicle.

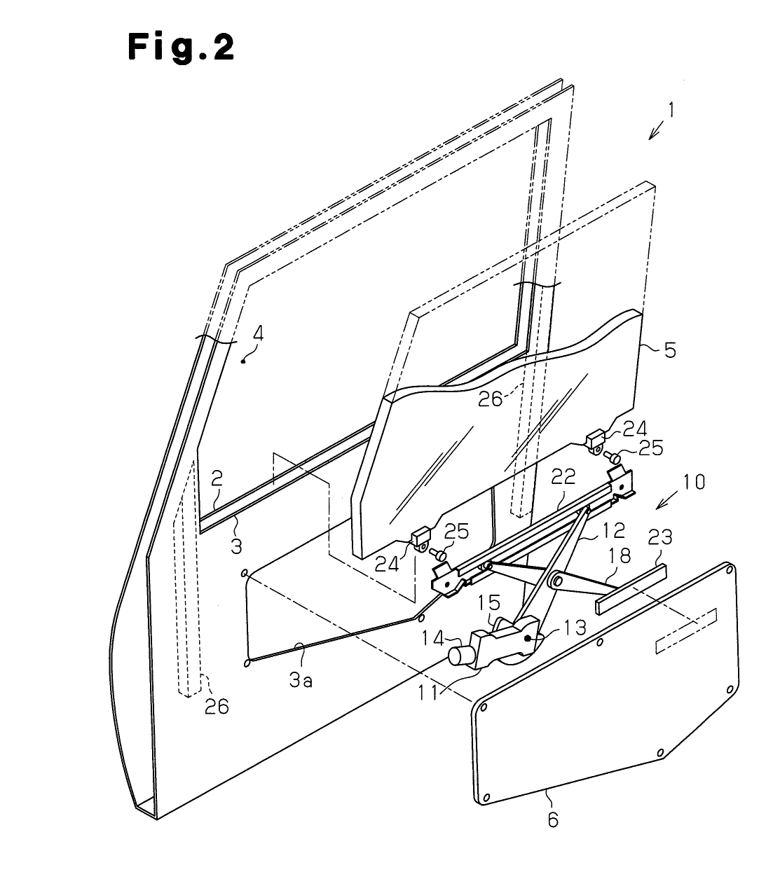

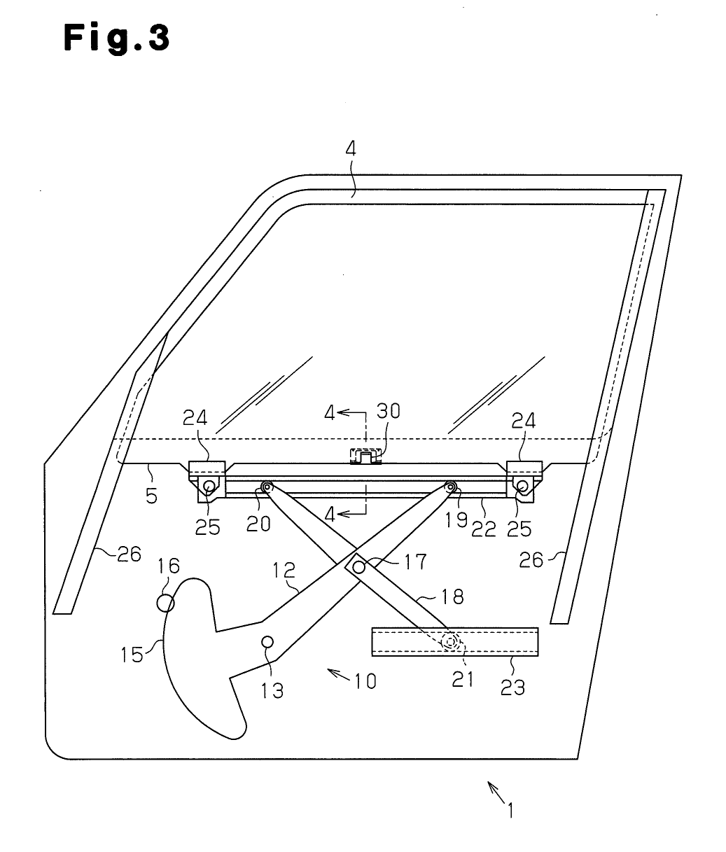

FIG. 2 is an exploded perspective view of a right front door of an automobile. FIG. 3 is a schematic front view of the right front door of the automobile.

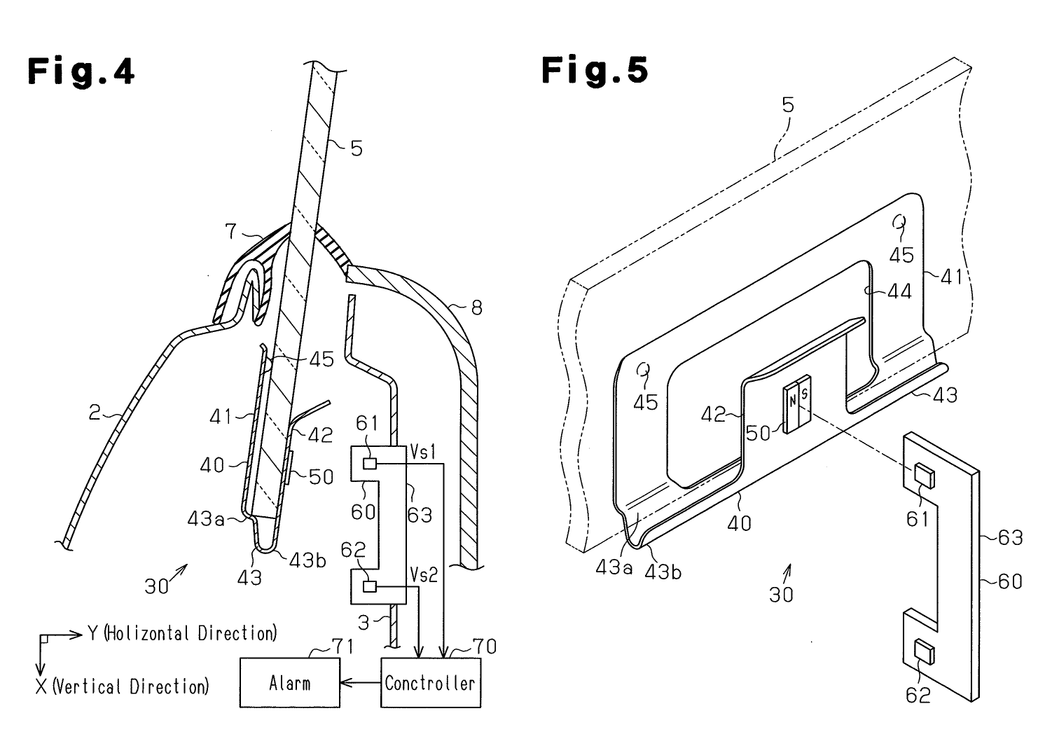

As illustrated in FIG. 2, a vehicle door 1 includes an outer panel 2 and an inner panel 3. A window glass 5 formed of hardened glass is disposed between the outer panel 2 and the inner panel 3. The window glass 5 has a thickness of about 3.1 mm to about 5.0 mm. A door trim 8 (see FIG. 4) is attached to inside the inner panel 3 of the vehicle door 1.

Within the vehicle door 1, a window regulator 10 is housed to move the window glass 5 in a vertical direction. In this embodiment, the window regulator 10 is an X-arm type window regulator. A hole 3a is provided in the inner panel 3, and a modular panel 6 is provided in a manner to cover the hole 3a.

The window regulator 10 is supported on the outside surface of the modular panel 6 via a base plate 11. In particular, the base plate 11, which is fixed to the modular panel 6 on the outside surface of the modular panel 6, supports an axis 13 of a lift arm 12 of the window regulator 10. An electric drive unit 14 is fixed to the base plate 11. As illustrated in FIG. 3, the lift arm 12 has an integral sector gear 15 around the axis 13. The electric drive unit 14 of FIG. 2 has a pinion 16 (FIG. 3) that mates with the sector gear 15, and a drive motor (not shown).

In FIG. 3, a middle portion of an equalizer arm is pivotably attached to a middle portion of the lift arm 12 in the longitudinal direction of the lift arm 12 at the position of an axis 17. A roller 19 and a roller 20 are rotatably and inclinably attached to the upper end of the lift arm 12 and the upper end of the equalizer arm 18, respectively. A roller 21 is pivotably attached to the lower end of the equalizer arm 18. Each roller 19, 20 and 21 serves as a guide piece.

The guide piece 19 of the lift arm 12 and the guide piece 20 of the equalizer arm 18 are fitted in a window glass bracket 22 to be movable therein. The guide piece 21 of the equalizer arm 18 is guided in an equalizer arm bracket 23. The equalizer arm bracket 23 is fixed on the outside surface of the modular panel 6 in FIG. 2, and includes rails for maintaining the attitude of the equalizer arm 18.

A window glass holder 24 is fixed at the lower edge of the window glass 5. The window glass holder 24 is fixed to the lower edge of the window glass 5 in advance. Then, the window glass 5 having the window glass holder 24 fixed thereto is inserted in a gap between the outer panel 2 and the inner panel 3, and fixed to the window glass bracket 22 with bolts 25.

As illustrated in FIG. 3, a pair of glass runners 26 are provided to extend in a vertical direction. These glass runners 26 are made of rubber. The pair of glass runners 26 serves as rails and support the window glass 5 so that the window glass 5 can move along the glass runners 26. That is, front and rear ends of the window glass 5 can move in a vertical direction with the guidance of the glass runners 26.

When a pinion 16 is rotated in a forward or reverse direction via an electric drive unit 14 of FIG. 2, the lift arm 12 swings around the axis 13 via the sector gear 15. As a result, the window glass bracket 22 and the window glass 5 move up or down while taking substantially horizontal positions, supported with the equalizer arm 18, the guide pieces 19.20.and 21, and the equalizer arm bracket 23. This vertical movement of the window glass 5 allows an opening 4 of a vehicle to open or close.

FIG. 4 illustrates a longitudinal cross-sectional view taken along the line 4-4 of FIG. 3. In FIG. 4, a breakage detection system 30 for an openable window glass for preventing unauthorized invasion is provided within the vehicle door 1. The breakage detection system 30 includes a clip 40 and a sensor unit 60.

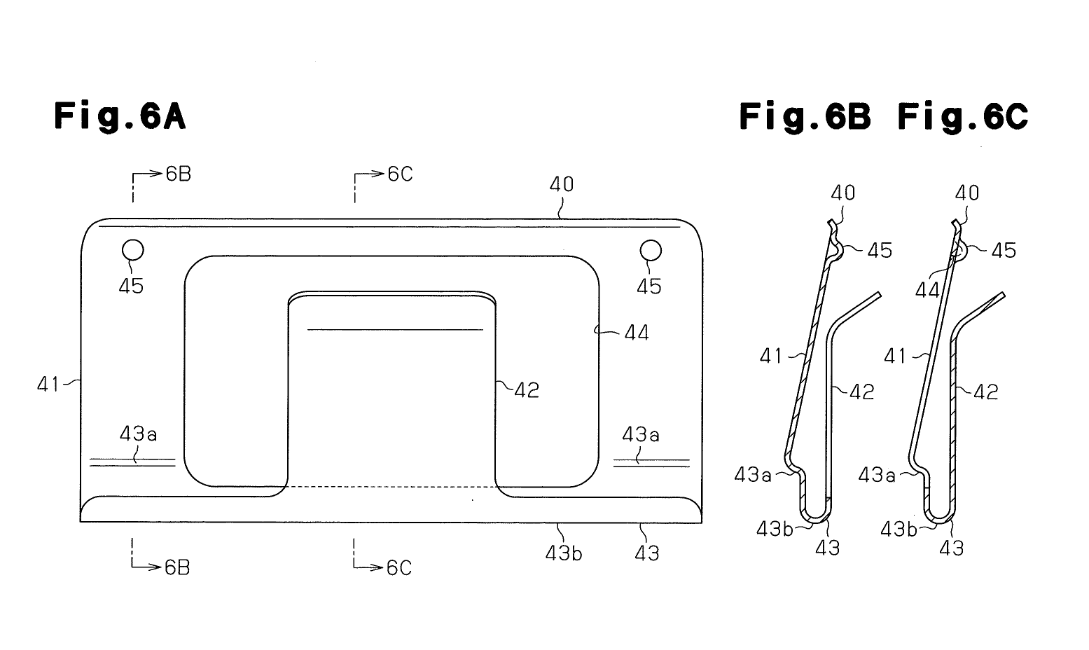

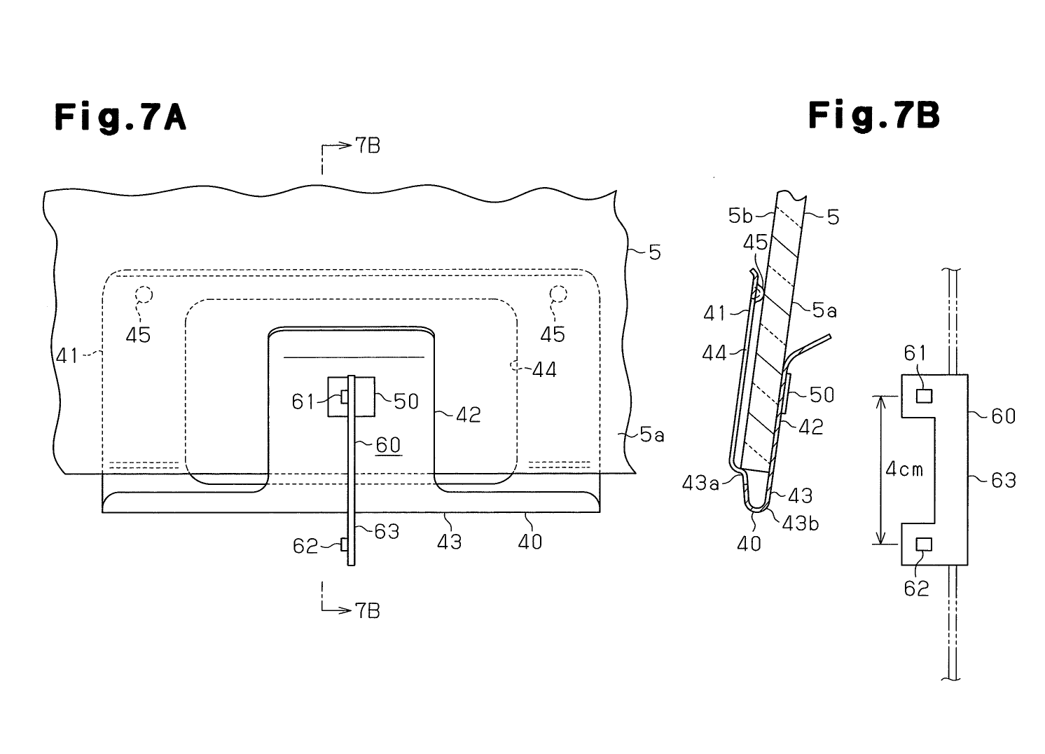

FIG. 5 illustrates a perspective view of the breakage detection system 30. FIGS. 6A-C illustrate the clip 40: FIG. 6A is a front view; FIG. 6B is a cross-sectional view along the line 6B-6B of FIG. 6A; and FIG. 6C is a cross-sectional view along the line 6C-6C of FIG. 6A. FIGS. 7A and 7B illustrate the breakage detection system 30: FIG. 7A is a front view; and FIG. 7B is a longitudinal cross-sectional view along the line 7B-7B of FIG. 7A.

In FIG. 4, the window glass 5 is placed between the outer panel 2 and the inner panel 3 in a sealed state with a weather-strip 7. The door trim 8 is placed inside the inner panel 3. The clip 40 is placed at the lower end of the window glass 5 to clip to the window glass 5.

As illustrated in FIGS. 6A-C, the clip 40 is formed by folding a sheet of steel plate for making a leaf spring. The clip 40 includes first and second members 41.42 that oppose each other and a folded portion 43 that connects the first member 41 with the second member 42. The first member 41 located on the back side is rectangular while the second member 42 located on the front side is square. The width of the second member 42 is narrower than that of the first member 41. The window glass 5 is placed between the first member 41 and the second member 42 (see FIGS. 7A and 7B). The first member 41 and the second member 42 are biased in a direction to approach each other with the window glass 5 interposed therebetween.

The folded portion 43 that connects the first member 41 with the second member 42 is folded twice. The first folded portion 43a contacts an end of the window glass 5. The width of the second folded portion 43b is narrower than the thickness of the window glass 5 (see FIG. 7B). That is, as illustrated in FIG. 7B, the folded portion 43 of the clip 40 forms two steps and the end of the window glass 5 contacts one step while the window glass 5 is not clipped at the lower end of the folded portion 43.

In FIG. 6A, a generally rectangular hole 44 is formed at the center of the first member 41. The second member 42 is located in a position corresponding to the hole 44. As illustrated in FIGS. 6A-C, protrusions 45 are formed at the upper left and right corners of the first member 41 to protrude toward the second member 42. As illustrated in FIG. 7B, distal ends of the protrusions 45 contact a rear surface 5b of the window glass 5. As illustrated in FIG. 7A, the second member 42 contacts a front surface 5a of the window glass 5 in a position corresponding to the hole 44 in the first member 41. Thus, the first member 41 contacts with the window glass 5 at two portions which are spaced each other, and the position in which the second member 42 contacts the window glass 5 is located between the two portions. A portion of the first member 41 that faces a portion of the window glass 5 (including the two contact positions where the first member 41 contacts the window glass 5) surrounds the portion where the second member 42 contacts the window glass 5. That is, as illustrated in FIG. 7A, the portion of the first member 41 that faces the window glass 5 is generally inverted U-shaped. This configuration facilitates breakup of the window glass 5 and ensures falling or dropping of the clip 40 after the breakage of the window glass 5. The second member 42 is attached to the window glass 5.

In this way, in the position between the first member 41 and second member 42 where the window glass 5 is interposed, the first member 41 and the second member 42 are biased in a direction to approach each other in contact with the window glass 5 on the different points of the window glass 5. In other words, forces are applied to the window glass 5 at different positions on the front surface 5a and the rear surface 5b. The clip 40 clips to the lower end of the window glass 5 with a predetermined force or greater.

As illustrated in FIGS. 5 and FIG. 7A, a permanent magnetic 50 is disposed on the front side of the second member 42 of the clip 40.

As illustrated in FIG. 4, the sensor unit 60 is fixed to the inner panel 3. As used herein, the X direction refers to a vertical direction and the Y direction refers to a horizontal direction. The clip 40 moves (i.e., falls) in the X-direction.

The sensor unit 60 includes a first magnetic sensor 61 and a second magnetic sensor 62, both of which are magnetic sensor elements, and a substrate 63. The first magnetic sensor 61 and the second magnetic sensor 62 are disposed on the substrate 63 at a distance in a vertical direction. Specifically, the magnetic sensors 61,62 are spaced at a distance of about 4 cm. The first magnetic sensor 61 is on the same level as the magnet 50 at the time when the window glass 5 is fully closed. The first magnetic sensor 61 is spaced apart from the magnet 50 at a predetermined distance in the Y direction. The second magnetic sensor 62 is located lower than the first magnetic sensor 61. When the clip 40 falls, the clip 40 passes in front of the second magnetic sensor 62.

Each magnetic sensor 61,62 outputs a signal corresponding to the distance of the sensor 61,62 from the magnet 50. In FIG. 4, since the first magnetic sensor 61 is on the same level as the magnet 50, output of the first magnetic sensor 61 is high. On the other hand, since the second magnetic sensor 62 is lower than the first magnetic sensor 61, output of the second magnetic sensor 62 is low. For example, the magnetic sensors 61,62 may be Hall ICs.

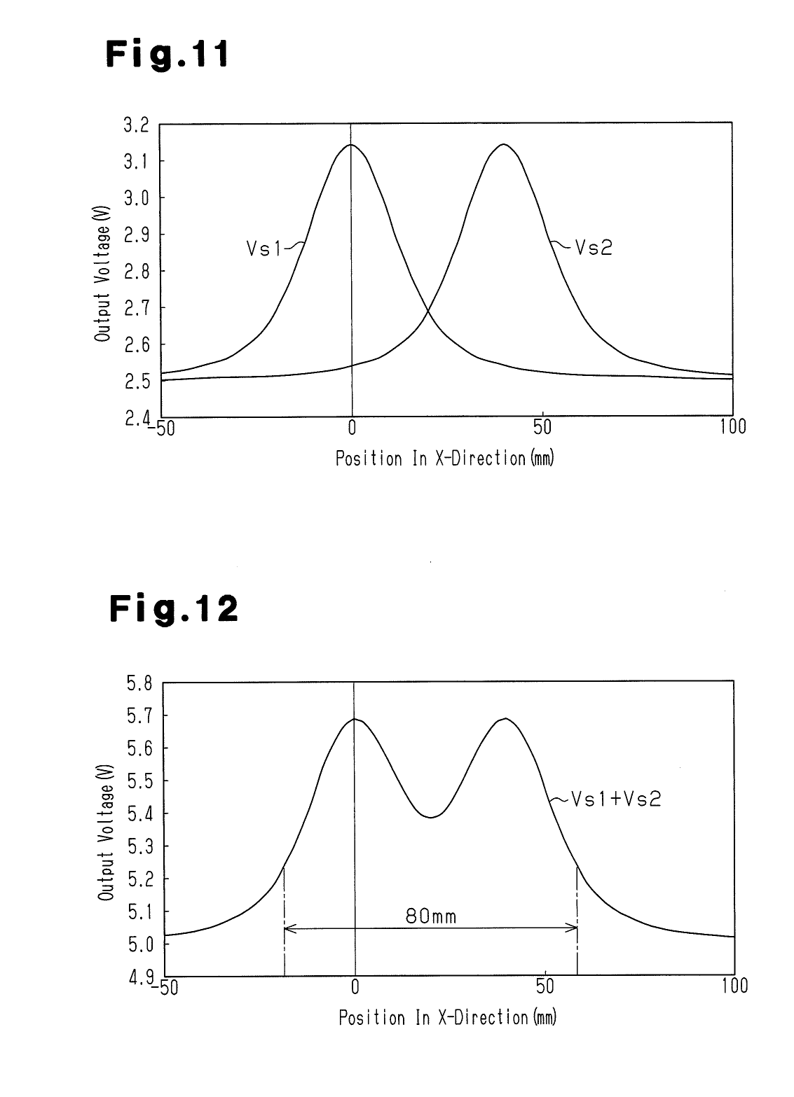

As illustrated in FIG. 4, the magnetic sensors 61,62 are connected with a controller 70. The controller 70 includes an A/D converter and a microcomputer. The microcomputer receives an A/D-converted version of the signals from the magnetic sensors 61.62 (digital output values Vs1 and Vs2). The microcomputer also adds the output values of the magnetic sensors 61.62 to figure out a sum (Vs1+Vs2), as illustrated in FIG. 12. Compared to the case of FIG. 11 where each output value Vs1, Vs2 of each magnetic sensor 61,62 is used, a high output level signal is obtained over a broad range (80 mm in FIG. 12). Consequently, the location of the magnet 50 can be detected over a broad range. In FIG. 4, an alarm 71 is connected to the controller 70.

Next, operation of the breakage detection system for an openable window glass, i.e., operation when the window glass 5 is broken, will be described.

Normally, as illustrated in FIGS. 7A and 7B, the window glass 5 is fully closed or slightly opened by a few centimeters when an occupant exits from a vehicle. The controller 70 detects the position of the window glass 5 based on the output level from the sensors of FIG. 12. The controller 70 sets a “glass breakage detecting mode” when the window glass 5 is fully closed or opened by a few centimeters during the time a parking brake is on. Meanwhile, the clip 40 disposed at the end of the window glass 5 clips to the end of the window glass 5. In particular, the clip 40 sandwiches the window glass 5 between the first member 41 and the second member 42 by its elastic force. The magnet 50 is located in front of the sensor 61 of the sensor unit 60.

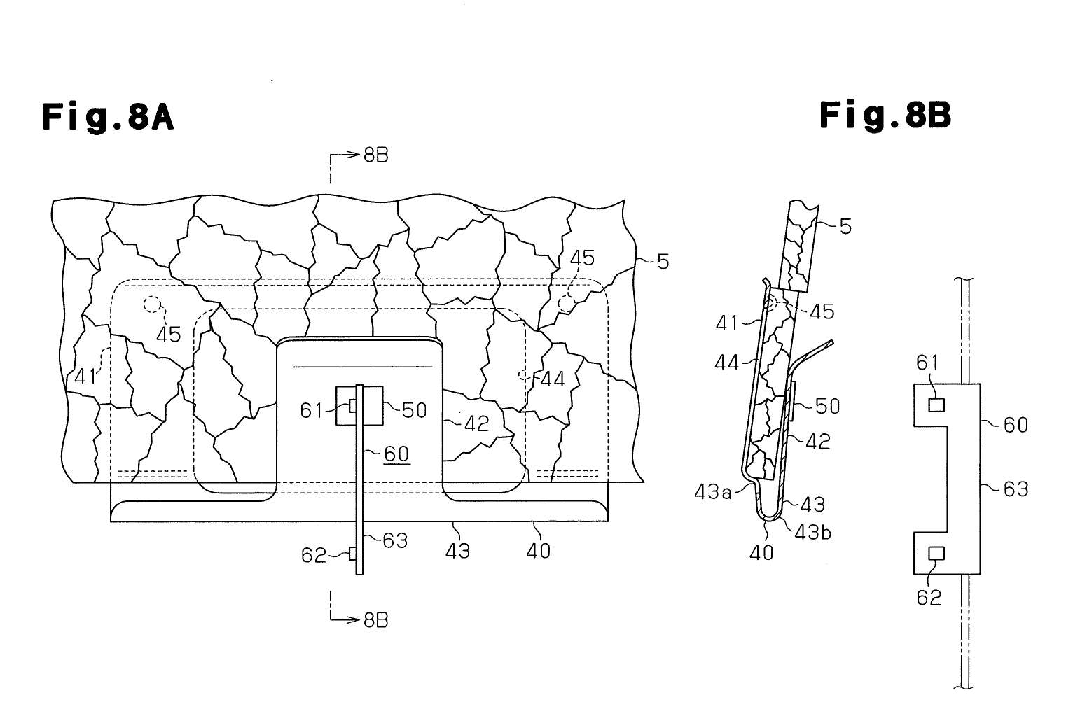

From this point, if a part of the window glass 5, which is hardened glass, is broken, the entire window glass 5 is cracked and strength thereof will be deteriorated, as illustrated in FIGS. 8A and 8B.

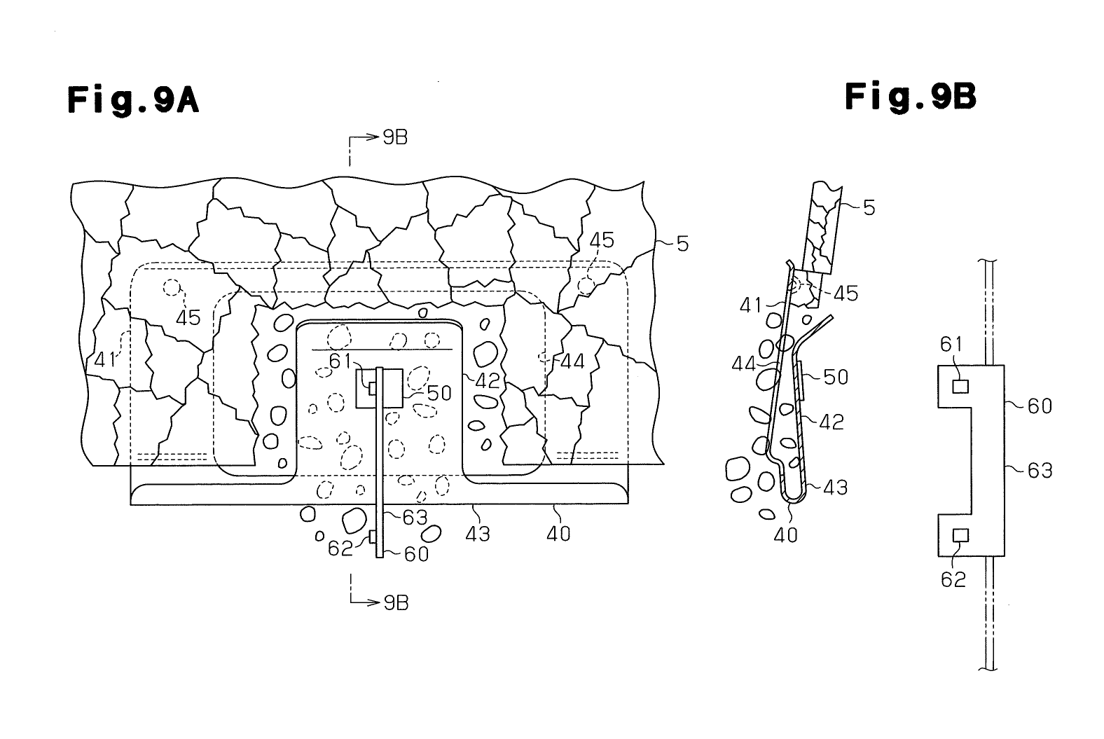

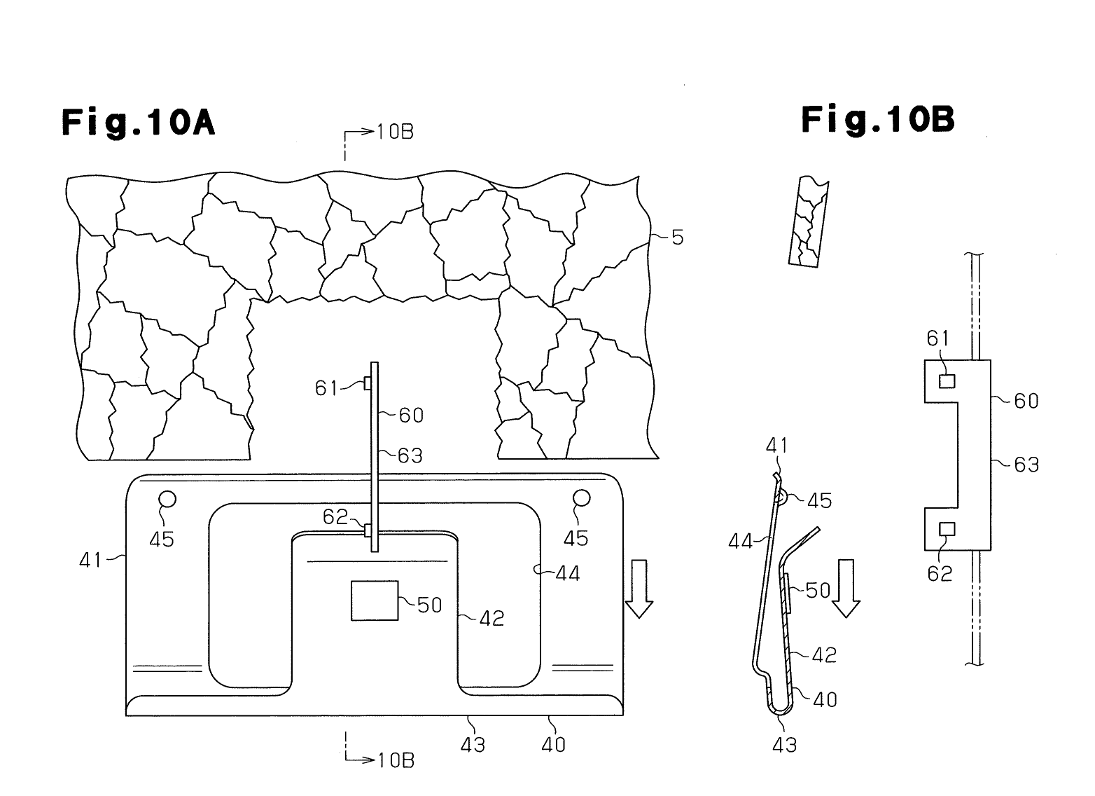

With this decrease in strength, as illustrated in FIGS. 9A and 9B, the clip 40 breaks the lower end of the window glass 5 into pieces via its clipping force. That is, the spring force of the clip 40 causes a part of the window glass 5 to break apart completely. Then, as illustrated in FIGS. 10A and 10B, the clip 40 falls in the direction of the arrow.

Specifically, as illustrated in FIGS. 8A and 8B, biasing force of the second member 42 urges the window glass 5 to contact the first member 41 of the clip 40. In this state, as illustrated in FIGS. 9A and 9B, the second member 42 pushes the window glass 5 with the portion of the window glass 5 surrounding the hole 44 supported by the first member 41. Then, the window glass 5 is broken apart at the position of the hole 44. The broken window glass 5 takes a generally inverted U-shape. Then, as illustrated in FIGS. 10A and 10B, the clip 40 falls.

Before the window glass 5 is broken, the sum of output signals of the magnetic sensors 61.62 (=Vs1.Vs2) of the sensor unit 60 indicates a predetermined value or above. However, when the clip 40 falls after the breakage of the window glass 5, the sum of the output signals of the magnetic sensors 61,62 indicates a value below the predetermined threshold. This enables detection of falling of the clip 40.

Hardened glass is entirely cracked when a part of the glass is broken, and the strength thereof is significantly decreased. This feature of hardened glass can be used to minimize failure of detection or erroneous detection.

As illustrated in FIG. 3, breakage of the window glass 5 can be detected even when the window glass 5 is not in a fully closed position because the clip 40 falls after the window glass 5 breaks. Conventionally, as described in Patent Document 1, the movement of the window glass from a fully closed position was detected. Thus, when the window glass is not in a fully closed position, breakage of the window glass could not be detected. However, in this embodiment, window glass breakage can be detected even when the window glass is in a position other than a fully closed position, such as the position where the window glass is slightly opened for air ventilation.

The clip 40 of FIGS. 7A and 7B is a bent steel plate for making a leaf spring, and includes the first member 41 and the second member 42 that oppose each other and sandwich the window glass 5 therebetween. The first member 41 and the second member 42 are biased in a direction to approach each other in contact with the window glass 5 at the different points of the window glass 5. Since forces are applied to the window glass 5 at different positions on the front surface 5a and the rear surface 5b, it is ensured that the end of the window glass 5 is broken apart and breakage of the window glass 5 is reliably detected.

In the clip 40 of FIGS. 7A and 7B, the portion of the first member 41 that contacts the window glass 5 and the portion of the second member 42 that contacts the window glass 5 are distant on the window glass 5. In addition, the portion of the first member 41 that faces the window glass 5 (including the two contact positions where the first member 41 contacts the window glass 5) surrounds the contact portion of the second member 42 that contacts the window glass 5. Thus, as illustrated in FIGS. 8A and 8B, the window glass 5 is pressed to contact the first member 41 at the position around the contact portion of the second member 42 with the window glass 5. That is, the window glass 5 is pressed within the hole 44 while supported with the first member 41 around the hole 44. As illustrated in FIGS. 9A and 9B, this configuration facilitates breaking apart the end of the window glass 5, and ensures falling or dropping of the clip 40.

In FIG. 4, when the sensor unit 60 detects the falling of the clip 40 to detect breakage of the window glass 5, the controller 70 activates the alarm 71 to issue a warning.

The first embodiment has the following advantages.
(1) The clip 40 serves as a detector for detecting breakage of an openable window glass. In other words, the clip 40 clips to the end of the window glass 5 that selectively opens or closes the opening 4 of a vehicle, and breaks the end of the window glass 5 into pieces following breakage of the window glass 5. Thus, the clip 40 is used to detect breakage of the openable window glass. As illustrated in FIGS. 7A and 7B, the clip 40 is a bent steel plate for making a leaf spring, and includes the first member 41 and the second member 42 that oppose each other. The first member 41 and the second member 42 are biased in a direction to approach each other in contact with the window glass 5 at the different points of the window glass 5. In other words, the clip 40 urges the glass surface 5a and the glass surface 5b of the window glass 5 in opposite directions toward each other by its elasticity. Thus, the end of the window glass 5 is reliably broken apart following breakage of the window glass 5 and detection of the breakage of the window glass 5 is ensured. Breakage of the window glass 5 can be detected even when the window glass 5 is not in a fully closed position.

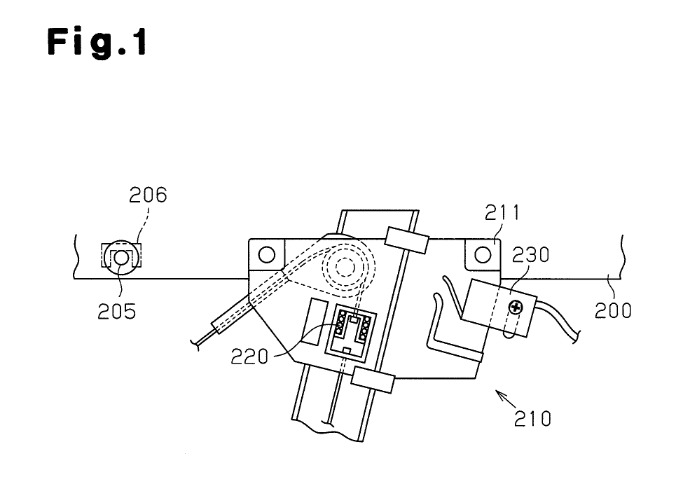

More specifically, in the prior art detection system of FIG. 1, displacement of the window glass 200 from a fully-closed position to a further advanced position was detected. Therefore, when the window glass 200 was not in the fully-closed position, i.e., when the window glass 200 was slightly opened for air ventilation, breakage detection of the window glass 200 was impossible. In contrast, according to this embodiment, breakage of the window glass 5 can be detected even when the window glass 5 is not in a fully-closed position.
(2) As illustrated in FIGS. 7A and 7B, the folded portion 43 that connects the first member 41 with the second member 42 is folded to form two steps. The width of the second folded portion 43b at the second step is narrower than the thickness of the window glass 5. The end of the window glass 5 contacts the first folded portion 43a at the first step. This allows the clip 40 to clip to the window glass 5 only near the lower end of the folded portion, and clipping force of the clip 40 against the window glass 5 is maintained. Accordingly, clipping to the end of the window glass 5 with the first member 41 and the second member 42, which are formed of a bent steel plate for making a leaf spring and oppose each other, is ensured.
(3) As illustrated FIGS. 7A and 7B, the contact portions of the first member 41 where the first member 41 contacts the window glass 5 are spaced at two positions on the surface of the window glass 5, and the contact portion of the second member 42 with the window glass 5 is located between the two positions. A portion of the first member 41 that faces a portion of the window glass 5 (including the two positions where the first member 41 contacts the window glass 5) surrounds the position where the second member 42 contacts the window glass 5. Thus, as illustrated in FIGS. 8A and 8B, the window glass 5 is pressed to contact the first member 41 at the positions around the contact portion of the second member 42 with the window glass 5. This configuration facilitates breakup of the end of the window glass 5 and ensures falling or dropping of the clip 40.
(4) As illustrated in FIGS. 7A and 7B, the first member 41 contacts the window glass 5 at the position of the protrusions 45. Thus, when the window glass 5 cracks, the window glass 5 can be broken apart with small force. In other words, force is applied to the window glass 5 efficiently.
(5) In prior art, a regulator needs to be processed and this may decrease reliability and quality. On the other hand, in this embodiment, a regulator need not to be processed and high reliability and quality is maintained. Moreover, whereas the prior art system has a complicated structure that tends to increase costs, this embodiment has a simple structure and a breakage detection system for an openable window glass provided for relatively low cost.

The first embodiment is not limited as described above but may be modified as follows.
(A) Instead of an X-arm type window regulator, the window regulator may be a cable-type window regulator.
(B) The drive unit is not limited to a drive unit including a motor but may be a unit manually operated by an occupant.
(C) The breakage detection system for window glass may be applied not only to the right front door of a vehicle but also one or more other side doors, a rear door other than the side doors, or a openable-type glass roof provided in the roof.
(D) Instead of the sensor unit 60 having a pair of magnetic sensors 61,62, the sensor unit 60 may include a single magnetic sensor.
(E) Other than a magnetic sensor, the sensor unit 60 may be an infrared sensor. An infrared reflection film may be provided in the second member 42 of the clip 40 to face such an infrared sensor. More specifically, in FIGS. 7A and 7B, an infrared reflection film may be provided instead of the magnet 50, and an infrared sensor may be provided instead of the magnetic sensor unit 60. The infrared sensor may emit an infrared light and cause the reflective film to reflect the infrared light. The presence of the reflected infrared light may be used to detect falling of the clip 40.
(F) The clip 40 may be disposed inconspicuously at the end of the window glass within the vehicle door 1. Other than the lower end of the window glass 5, the clip 40 may also be disposed on the lower part of the lateral side of the window glass 5.
(G) When the second member 42 of the clip 40 is attached to the window glass 5, an elastic sheet may be disposed between the second member 42 and the window glass 5 to prevent slippage of the second member 42 off from the window glass 5.
(H) Instead of providing the protrusions 45 that contact the window glass 5 in the first member 41 of the clip 40, the protrusions may be provided in the second member 42. Alternatively, the protrusions may be provided both in the first member 41 and in the second member 42. Any configuration will do as long as at least one of the first member 41 and the second member 42 contacts the window glass 5 at the position of the protrusions. Further, the protrusions may be omitted both in the first member 41 and in the second member 42 as long as the clip 40 has sufficient clipping force to break apart the end of the window glass 5 when the strength of the glass is decreased.
(I) The detector may be attached to fixed window glass instead of an openable window glass.

Next, the second embodiment will be described, with the difference from the first embodiment focused on.

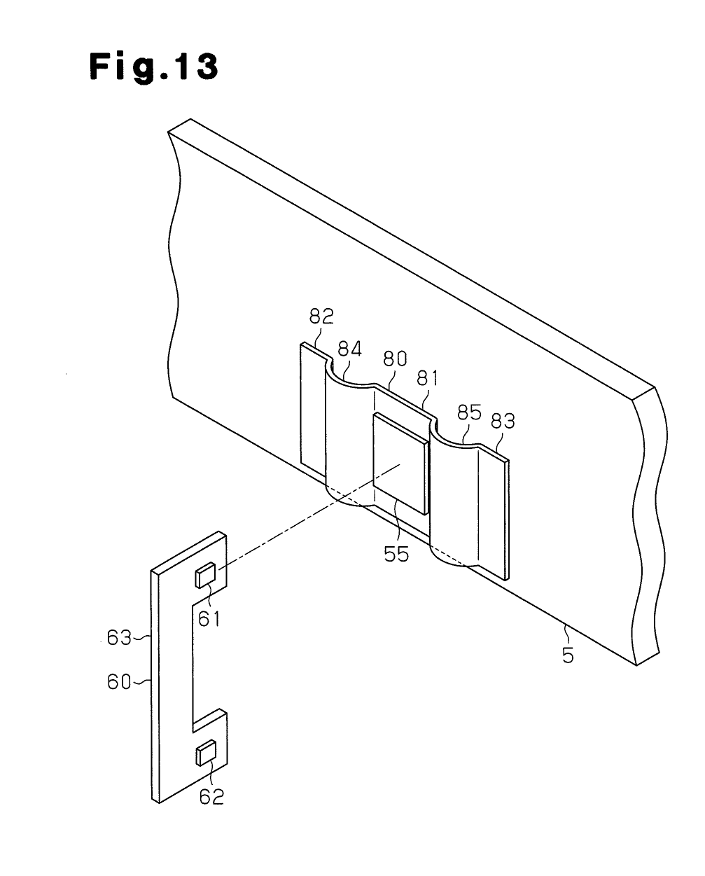

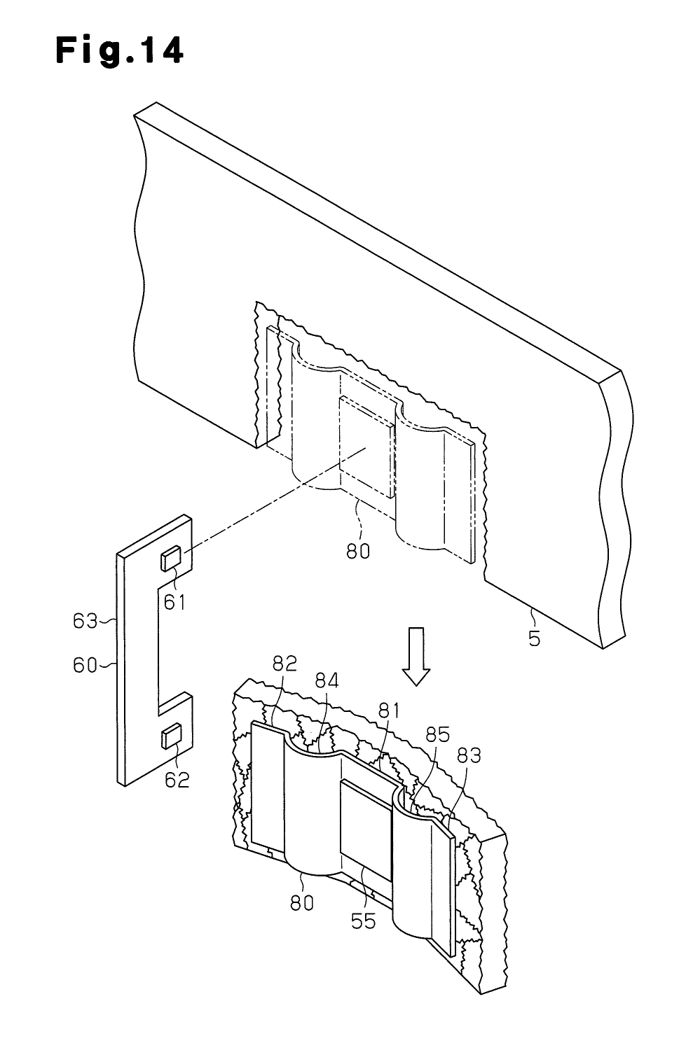

FIG. 13 is a perspective view of a detector 80 and a sensor unit 60 according to the second embodiment. FIG. 13 is a view before the window glass 5 is broken while FIG. 14 is a view when the window glass 5 was broken.

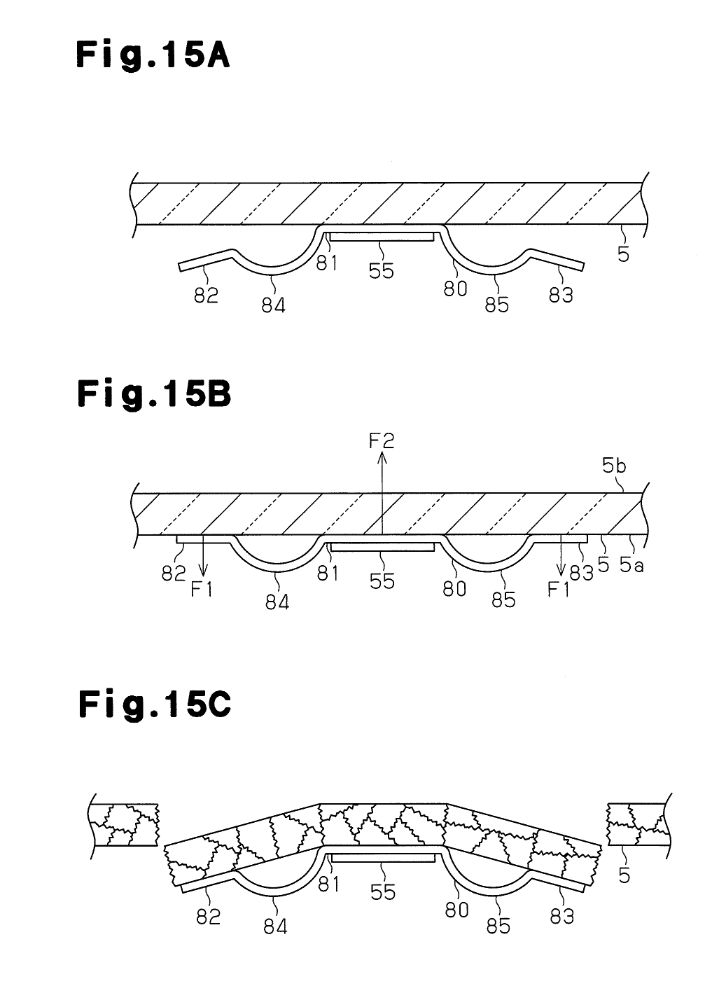

FIGS. 15A-C illustrate the detector 80. FIG. 15A is a view before the detector 80 is attached to the window glass 5. FIG. 15B is a situation where the detector 80 is attached to the window glass 5. FIG. 15C is a view when the window glass 5 was broken. The detector 80 of the second embodiment is different from the clip 40 of the first embodiment in that, instead of clipping the window glass 5, the detector 80 is adhered to one side of the window glass 5. The detector 80 may be attached to the window glass 5 in a position other than the end of the window glass 5.

In FIG. 13, displacement of at least a part of the detector 80 following the breakage of the window glass 5 is detected by the sensor unit 60 that serves as a detection device.

The detector 80 is formed by folding a band of steel plate for making a leaf spring. The detector 80 includes a first contact portion 81, a second contact portion 82, a third contact portion 83, a first biasing arm 84, and a second biasing arm 85. The first contact portion 81 is in the form of a flat plate. The first biasing arm 84 extends from the left side of the first contact portion 81 in an arcuate form. The contact portion 82 in the form of a flat plate is connected to the distal end of the first biasing arm 84. Similarly, the second biasing arm 85 extends from the right side of the first contact portion 81 in an arcuate form. The third contact portion 83 in the form of a flat plate is connected to the distal end of the second biasing arm 85. A permanent magnet 55 in the form of a plate is fixed to the first contact portion 81.

As illustrated in FIG. 15A, before the detector 80 is attached to the window glass, the first contact portion 81 contacts one side of the window glass 5 while the contact portion 82 and the third contact portion 83 are separate from the one side of the window glass 5.

Then, as illustrated in FIG. 15B, the second contact portion 82 and the third contact portion 83 of the detector 60 are attached to the window glass 5 against spring forces of the detector 80. Then, the second contact portion 82 and the third contact portion 83 of the detector 60 are urged toward the front surface 5a of the window glass 5 by forces F1 while the first contact portion 81 is urged toward the rear surface 5b of the window glass 5 by force F2. In this situation, the window glass 5 is urged toward the surface 5a and the surface 5b in opposite directions each other at the offset positions on the surfaces 5a and 5b of the window glass 5. In other words, the forces F1 and the force F2 are applied to the window glass 5 alternately.

In the situation of FIG. 15B, when the window glass 5 is broken, strength of the window glass 5 is decreased. Then, as illustrated in FIG. 15C, following the breakage of the window glass 5, the detector 80 breaks a part of the window glass 5 into pieces by biasing force thereof. Then, as illustrated in FIG. 14, the detector 80 falls in the direction of the arrow together with the magnet 55, and this falling of the magnet 55 is detected by the sensor unit 60, i.e., by the magnetic sensors 61,62. As a result, breakage of the window glass 5 can be detected.

Breakage of the window glass 5 can be detected even when not the entire window glass 5 is broken apart. In addition, even when the window glass 5 is not in the fully-closed position, breakage of the window glass 5 can be detected. Since two pairs of contact portions connected to their respective biasing arms 84, 85 on one side of the glass window 5, i.e., a pair of contact portions 81 and 82 and another pair of contact portions 81 and 83, bias the window glass 5 in opposite directions at offset positions, and this facilitates at least a portion of the window glass 5 breaking apart following breakage of the window glass 5. Thus, detection of the breakage of the window glass 5 is ensured.

In the detector 80, the first contact portion 81 is connected with the contact portions 82 and 83 at its left and right sides via the arms 84 and 85, respectively. However, the first contact portion 81 may be connected with one contact portion via one arm. In this case, the two contact portions are attached to one side of the window glass 5. Alternatively, the first contact portion 81 may be connected with at least three contact portions via at least three arms. Instead of a steel plate for a leaf string, the detector 80 may be made of other elastic material such as a carbon.

The second embodiment has the following advantage.
(1) In the window glass breakage detector 80, at least a pair of the contact portions (i.e., at least one of a pair of the contact portion 81 and the contact portion 82 and a pair of the contact portion 81 and the contact portion 83) are connected to the biasing arms 84 (85) on one side of the window glass 5, and contact the window glass 5 at offset positions while being biased against the window glass 5 in opposite directions. Thus, the detector 80 contacts the window glass 5 at offset positions and biases the glass surfaces 5a and 5b in the opposite directions by its elasticity. In this embodiment, the detector 80 can be attached to only one side of the window glass 5 without clipping, and the detector 80 can be attached to the window glass 5 at the position other than the end of the window glass 5.
(2) The detector 80 can be attached to a window glass 5 that selectively opens or closes an opening of a vehicle. Thus, breakage of the window glass 5 can be detected even when the window glass 5 is not in the fully closed position.

Next, a third embodiment will be described, with the difference from the first embodiment focused on.

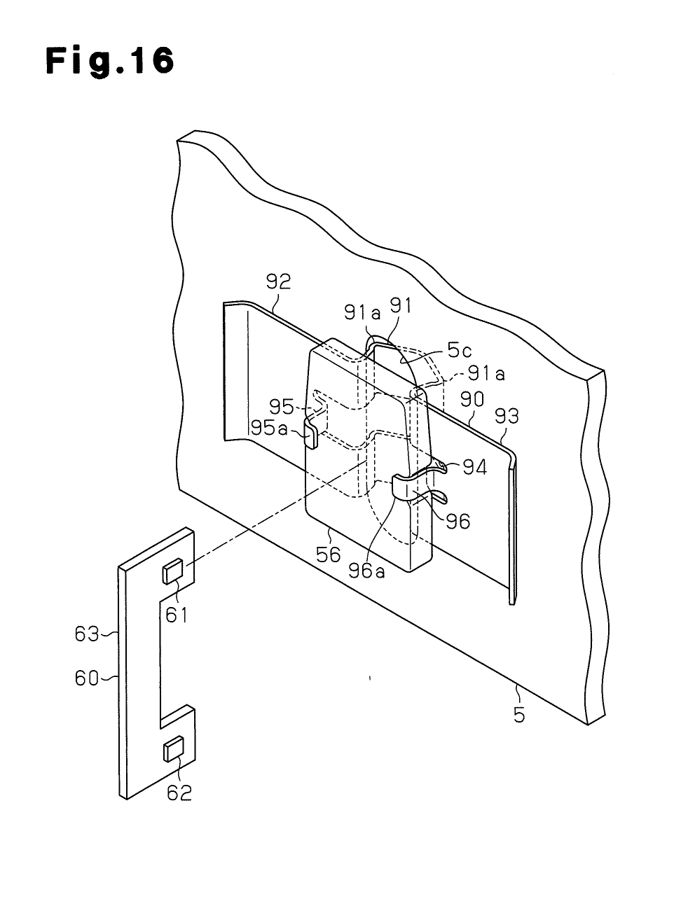

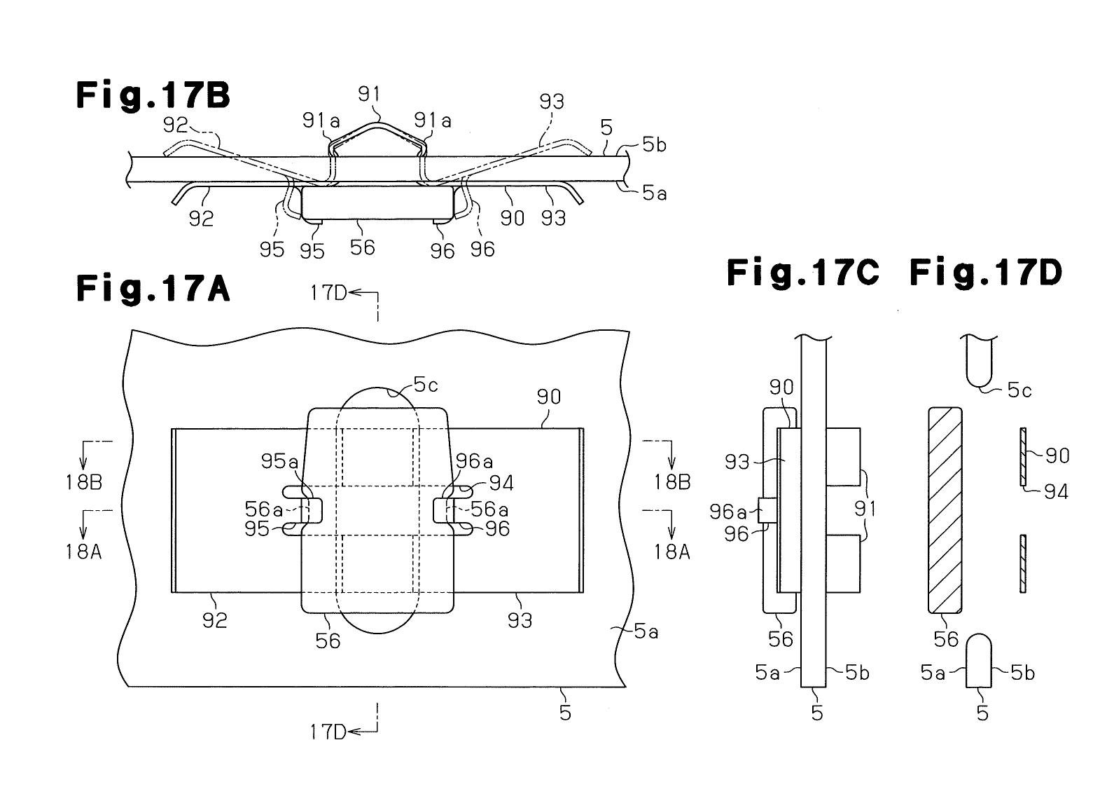

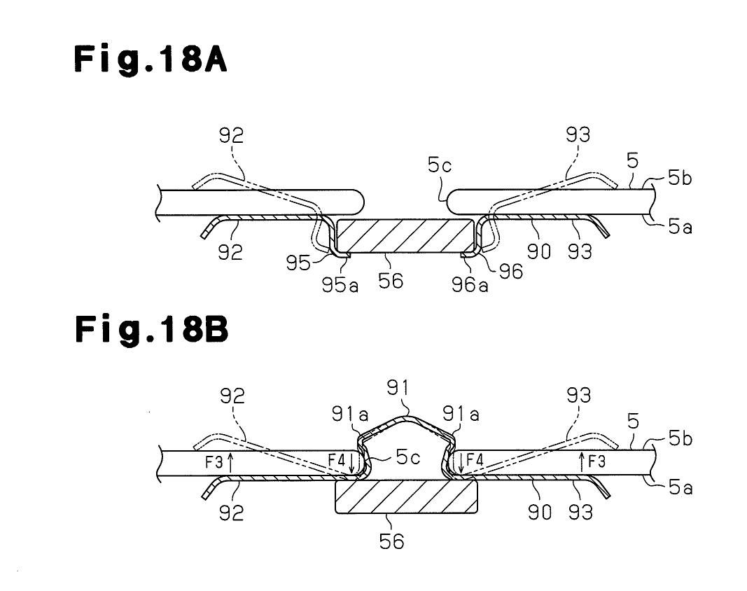

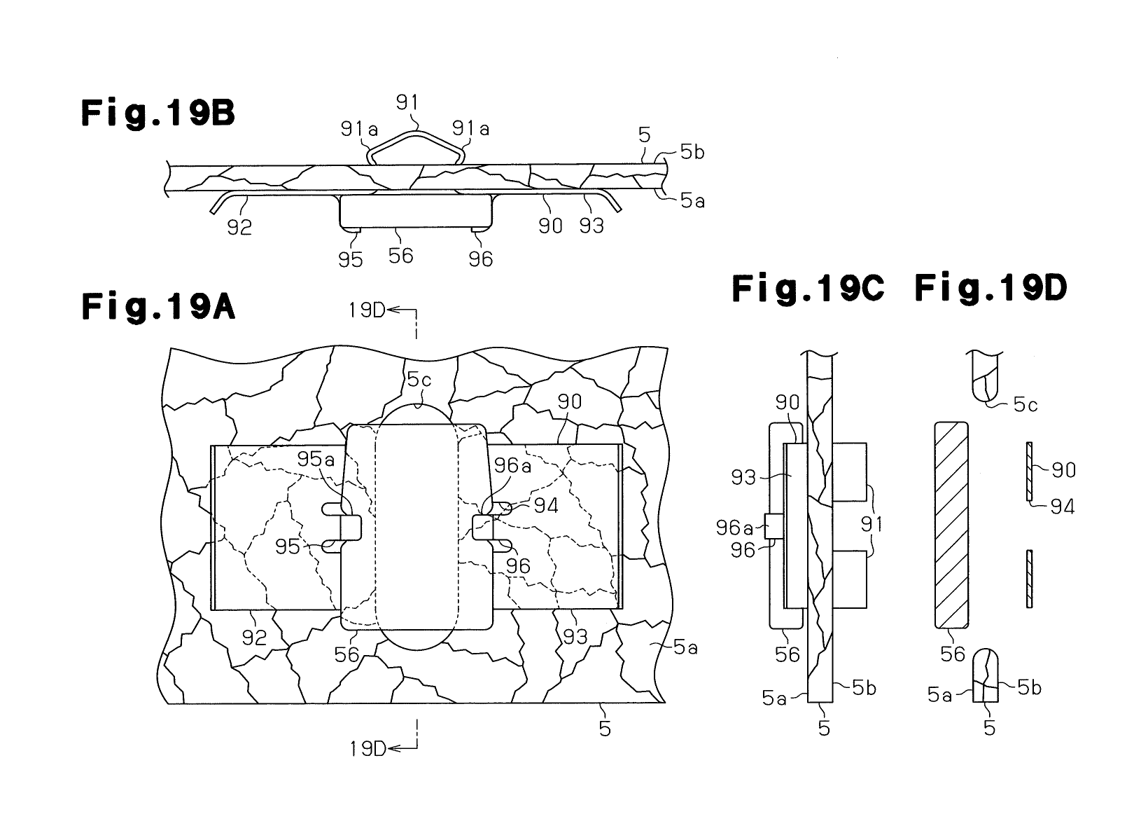

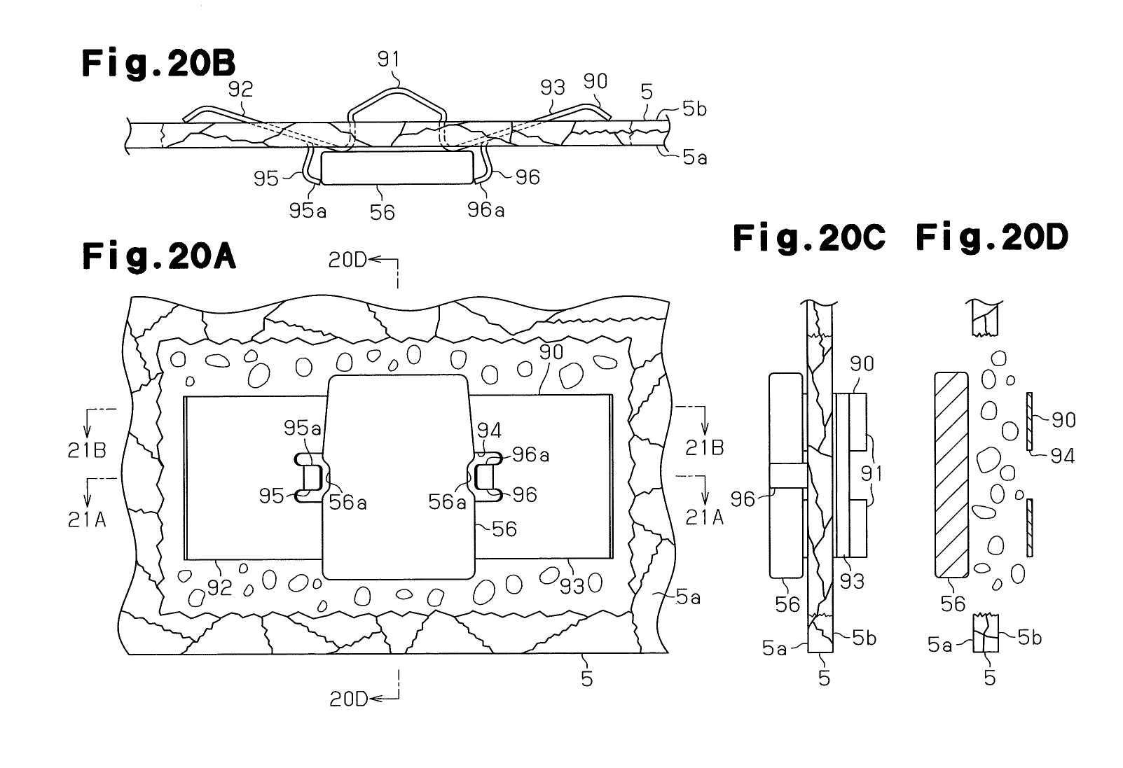

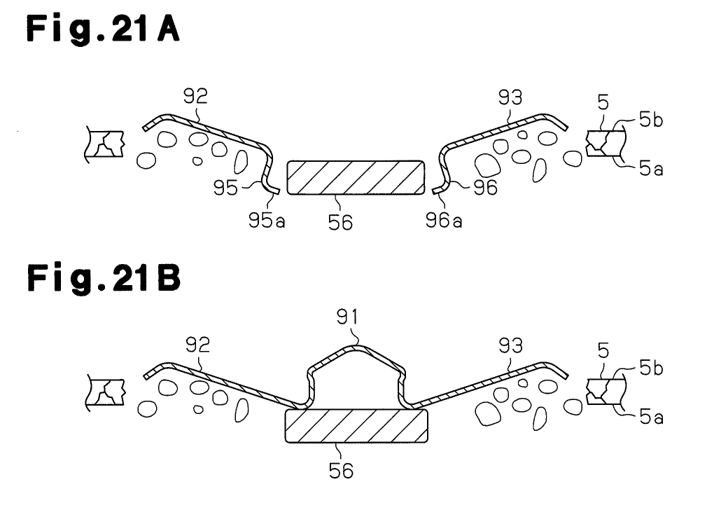

FIG. 16 is a perspective view of a detector 90 and a sensor unit 60 according to the third embodiment. FIGS. 17A-D illustrate the detector 90. FIG. 17A is a front view, FIG. 17B is a plan view, FIG. 17C is a side view, and FIG. 17D is a longitudinal cross-sectional view taken along the line 17D-17D of FIG. 17A. FIG. 18A is a cross-sectional view along the line 18A-18A of FIG. 17A. FIG. 18B is a cross-sectional view along the line 18B-18B of FIG. 17A. FIG. 17A-D and FIGS. 18A,B illustrate a situation where the detector 90 is attached to the window glass 5. FIGS. 19A-D illustrate a situation where the window glass 5 is broken and cracked entirely after the detector 90 was attached to the window glass 5. FIGS. 20A-D and FIGS. 21A and 21B illustrates a situation where the window glass 5 is broken and a part of the window glass 5 is broken apart.

As illustrated in FIG. 16 and FIG. 17A, a through-hole 5c is formed in the window glass 5. The through-hole 5c is an elongate hole that extends in a vertical direction. The detector 90 is fixed to extend through the through-hole 5c. The plates 92 and 93 of the detector 90 contact the surface 5a of the window glass 5. A permanent magnet 56 serving as a detectable member is held on the surface 5a of the window glass 5.

As illustrated in FIG. 16, the detector 90 holds the magnet 56 on the front side of the detector 90 when an openable window glass is unbroken, and releases the magnet 56 when the window glass is broken. The magnet 56 is in the form of a generally rectangular plate. A channel-like notch or recess 56a is formed on the left and right sides of the magnet 56 (see FIG. 20A).

As illustrated in FIG. 16, the detector 90 is formed by folding a band of a steel plate for making a leaf spring. The detector 90 includes a fixing portion 91 and plates 92,93. The fixing portion 91 is channel-like and deformable so as to be inserted into the through-hole 5c of the window glass 5. The plates 92,93 are in rectangular form and extend in a horizontal direction from the fixing portion 91. As illustrated in FIG. 18B, the width between the engaged portions 91a of the fixing portion 91 on the back surface 5b of the window glass 5 is greater than the width of the through-hole 5c of the window glass 5. Each of the engaged portions 91a contacts an edge of the window glass 5 that defines the through-hole 5c. On the side of the surface 5a of the window glass 5, each plate 92, 93 deforms to resist its spring force from a position indicated by a dot dashed line to a position indicated by a solid line in FIG. 17B and FIGS. 18A and 18B, thereby biasing the surface 5a of the window glass 5. In other words, the engaged portion 91a of the fixing portion 91 and the plates 92 and 93 sandwich the window glass 5 via the through-hole 5c on both sides of the window glass 5. The engaged portion 91a of the fixing portion 91 and the plates 92 and 93 urge the window glass 5 on the front surface 5a and the rear surface 5b in opposite directions at positions apart from the through-hole 5c at different distances, as indicated by forces F3 and forces 4 in FIG. 18B. Thus, before the detector 90 is attached to the window glass 5, the plates 92.93 are located in the position indicated by the dot dashed line in FIG. 18B whereas, after the detector 90 is attached to the window glass 5, the plates 92,93 deform toward the surface 5a of the window glass 5 to bias the surface 5a as indicated by the solid line in FIG. 18B.

As illustrated in FIGS. 17A and 17B, the detector 90 includes a pair of arms 95 and 96 that serve as holding portions for holding the permanent magnet 56. The pair of arms 95 and 96, together with the plates 92 and 93, hold the magnet 56 when the window glass 5 is unbroken, and release the magnet 56 when the window glass 5 is broken.

Specifically, a hole 94 is formed at the center of the detector 90 in the right and left directions. The arms 95 and 96 protrude from the wall of the detector 90 that defines the hole 94. Each of the arms 95 and 96 is a plate that extends generally linearly but folded twice at its distal end, as illustrated in FIG. 18A. When the detector 90 is attached to the window glass 5, corners of the parts of the permanent magnet 56 that define the recess 56a engage with the magnet engaging portion 95a, 96a of the distal end of the arms 95, 96 to lock the permanent magnet 56 in both the left-and-right direction and up-and-down directions. In FIG. 18A, the dot-dashed line represents the location of the arms 95 and 96 before the detector 90 is attached to the window glass 5, where the arms 95 and 96 are apart from the magnet 56. Then, when the detector 90 is attached to the window glass 5, as illustrated in the solid line in FIG. 18A, the arms 95 and 96 deform to lock both lateral sides of the magnet 55 from the front at the positions of the magnet engaging portions 95a and 96.

As illustrated in FIG. 19A-D, when the window glass 5 is broken, strength of the window glass 5 is decreased. This causes the detector 90 to break a portion of the window glass 5 apart around the through-hole 5c by its biasing force, as illustrated in FIGS. 20A-D and 21A. Thus, breakage of the window glass 5 can be detected.

This configuration enables reliable detection of breakage of the window glass 5 even when the window glass 5 is not perfectly broken apart after breakage of the window glass 5. In addition, breakage of the window glass 5 can be detected even when the window glass 5 is not located in a fully closed position.

The engaging portion 91a of the detector 90 and the plates 92, 93 clamp both sides of the window glass 5, and bias the window glass 5 on one and the other surfaces thereof in a direction to approach each other at different distances from the through-hole 5c. This configuration facilitates breakup of a part of the window glass 5 following the breakage of the window glass 5. Thus, detection of the breakage of the window glass 5 is ensured.

When the window glass is broken, the magnet 56 is released, and falling of the magnet 56 can be detected. Thus, even when the falling of the detector 90 is interfered with, for example, by being trapped somewhere or fixed to the car body (e.g., to the window glass 5), breakage of the window glass can be detected.

The third embodiment has the following advantages.

(1) The detector 90 clamps the window glass 5 from both sides of the window glass 5 by extending through the through-hole 5c in the window glass 5, and the detector 90 biases the window glass 5 in a direction that the detector 90 (i.e., the engaging portions 91a and the plates 92,93)) approaches itself on one and the other surfaces at positions spaced apart from the through-hole 5c at different distances. Then, the detector 90 contacts the window glass 5 at the offset position on the window glass 5, and biases itself in opposite directions against the glass surfaces 5a and 5b by its biasing force. Accordingly, the detector 90 can be attached at a position other than the end of the window glass 5.

(2) The detector 90 is attached to the window glass 5 that selectively opens or closes an opening of a vehicle. Thus, breakage of the window glass 5 can be detected even when the window glass 5 is not in the fully closed position.

Next, a fourth embodiment will be described, with the differences from the first embodiment being focused on.

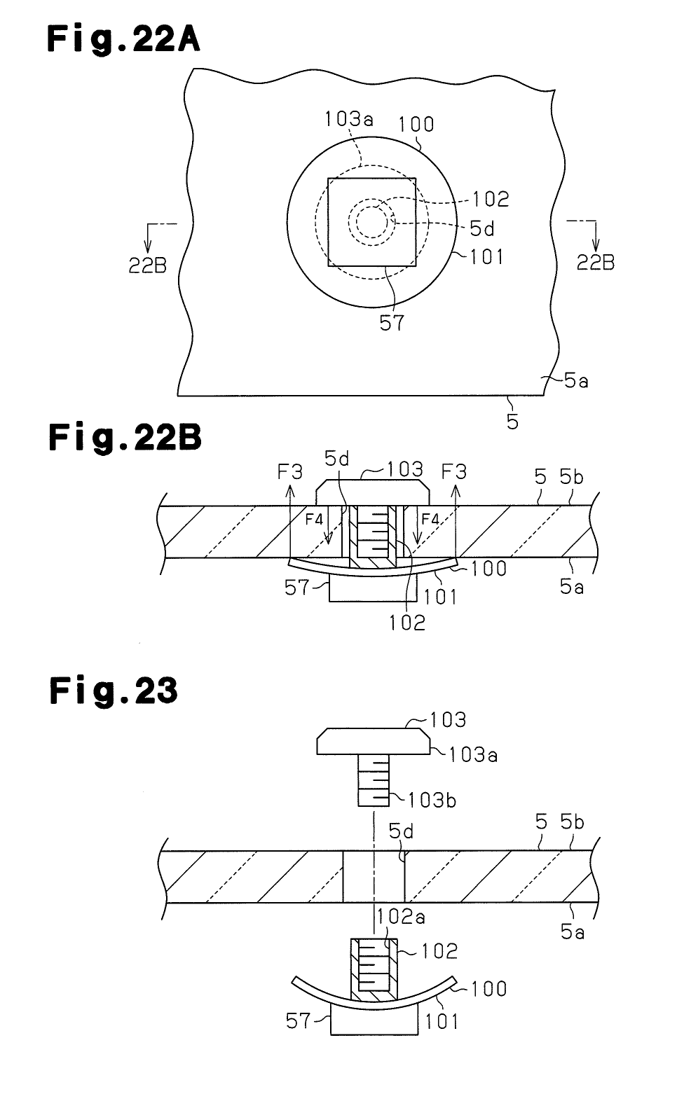

FIGS. 22A and 22B illustrate a detector 100 according to the fourth embodiment. FIG. 22A is a front view. FIG. 22B is a cross-sectional view taken along the line 22B-22B of FIG. 22A. FIG. 23 is a cross-sectional view of the detector 100 in an exploded state. This embodiment is a modified version of the third embodiment. A circular through-hole 5d is formed in the window glass 5.

As illustrated in FIG. 23, the detector 100 includes a circular arc portion 101, a connecting portion 102, and a fixing portion 103. The circular arc portion 101 is a circular, curved elastic member. The connecting portion 102 is a cylinder that is fixed to the center of the inner side of the circular arc portion 101. The diameter of the connecting portion 102 is slightly smaller than the diameter of the through-hole 5d of the window glass 5. The connecting portion 102 is inserted into the through-hole 5d from the side of the surface 5a of the window glass 5. An inner peripheral face 102a of the connecting portion 102 is threaded. A magnet 57 is fixed to the outer peripheral surface of the circular arc portion 101. The fixing portion 103 includes a screw, and a thread portion 103b extends from a head 103a. The diameter of the head 103a is slightly greater than the diameter of the through-hole 5d of the window glass 5. In the state of FIG. 23, the thread portion 103b of the fixing portion 103 is inserted from the rear surface 5b of the window glass 5 to mate with the inner peripheral face 102a of the connecting portion 102. As illustrated in FIGS. 22A and 22B, the circular arc portion 101 is attached in a compact configuration. At this timing, as illustrated in FIG. 22B, forces F3 and forces F4 are applied alternately to the window glass 5. This allows the detector 100 to clip to the window glass 5 from both sides. The detector 100 biases the window glass 5 in a direction approaching each other on one and the other surfaces at different distances from the through-hole 5d.

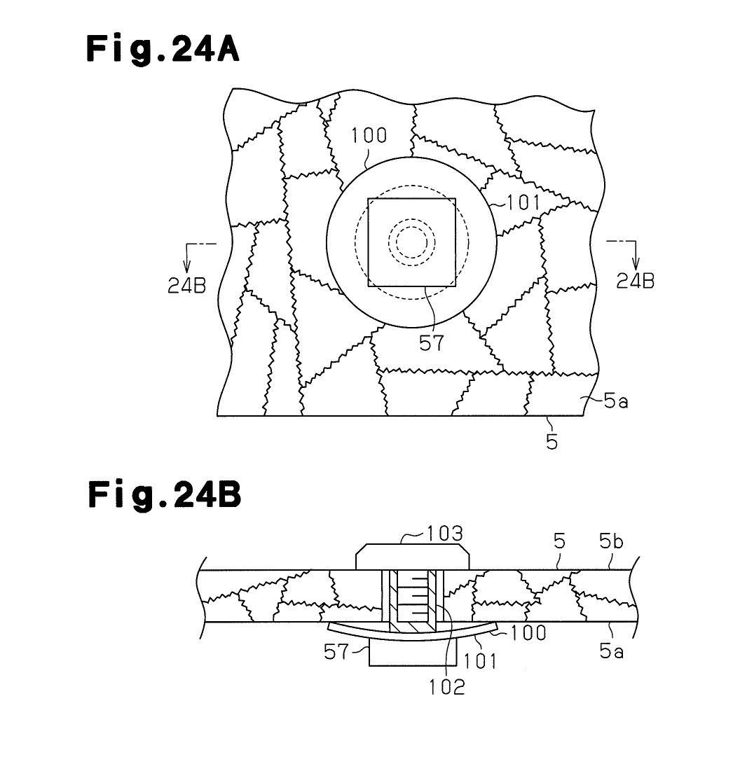

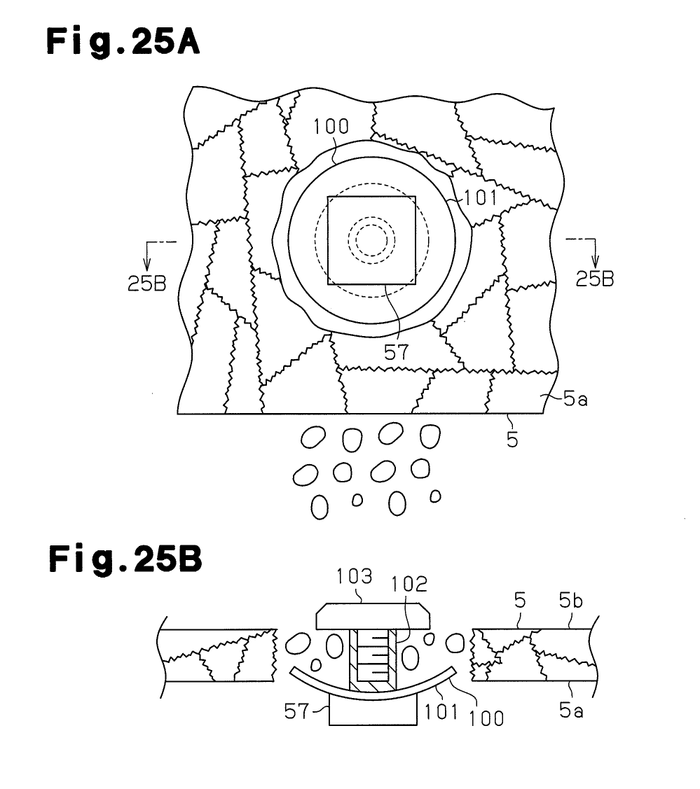

As illustrated in FIGS. 24A and 24B, when the window glass 5 is broken, the strength of the window glass 5 is decreased. This causes the detector 100 to break a portion of the window glass 5 apart around the through-hole 5d by its biasing forces F3 and F4, as illustrated in FIGS. 25A and 25B. Thus, breakage of the window glass 5 can be detected. In addition, the detector 100 can be attached to the window glass 5 without adhesion to the window glass 5.

The fourth embodiment has the following advantages.
(1) The detector 100 clamps the window glass 5 from both sides of the window glass 5 by extending through the through-hole 5d in the window glass 5, and the detector 100 biases the window glass 5 in a direction that the detector 100 approaches portions of itself on one surface and the other surface at positions spaced apart from the through-hole 5d at different distances. Then, the detector 100 contacts the window glass 5 at the offset position on the window glass 5, and biases itself in opposite directions against the glass surfaces 5a and 5b by its biasing force. Accordingly, the detector 100 can be attached at a position other than the end of the window glass 5.
(2) The detector 100 is attached to the window glass 5 that selectively opens or closes an opening of a vehicle.

Thus, breakage of the window glass 5 can be detected even when the window glass 5 is not in the fully closed position.

Each of the second, third, and fourth embodiments may be embodied as having any one of more of the items (A)-(E) and (I) described with respect to the first embodiment.

1. A window glass breakage detector, comprising a detector attachable to a window glass of a vehicle, wherein breakage of the window glass is detected by breaking at least a part of the window glass apart following the breakage of the window glass, wherein the detector biases a surface of the window glass by elasticity of the detector in opposite directions, in contact with the surface of the window glass at offset positions on the window glass.

2. A window glass breakage detector, comprising a detector clippable to a window glass that selectively opens or closes an opening of a vehicle at an end of the window glass, wherein breakage of the window glass is detected by breaking at least a part of the window glass apart following the breakage of the window glass, wherein the detector includes a first member and a second member that oppose each other, wherein the first member and the second member are formed by folding a steel plate for making a leaf spring, wherein the first member and the second member are biased in a direction to approach each other, in contact with a surface of the window glass disposed between the first member and the second member at offset positions on the window glass.

3. The window glass breakage detector of claim 2, wherein the detector further comprises a folded portion that connects the first member with the second member, wherein the folded portion is folded twice, wherein the width of the second folded portion is narrower than the thickness of the window glass, and the end of the window glass contacts the first folded portion.

4. The window glass breakage detector of claim 2, wherein the contact portions of the first member with the window glass are at two positions separated from one another so that the contact portion of the second member with the window glass is located between the two positions, wherein a portion of the first member that faces the window glass including the contact portions of the first member with the window glass surrounds the contact portion of the second member with the window glass.

5. The window glass breakage detector of claim 2, wherein at least one of the first member and the second member contacts the window glass at protrusions.

6. The window glass breakage detector of claim 1, wherein the window glass selectively opens or closes an opening of a vehicle.

7. The window glass breakage detector of claim 1, wherein the detector includes a biasing arm and a pair of contact portions connected to the biasing arm, wherein the pair of contact portions are biased in opposite directions from each other with respect to the surface of the window glass on one side of the window glass, and are in contact with the surface of the window glass at the offset portions on the window glass.

8. The window glass breakage detector of claim 1, wherein the window glass includes a through-hole, wherein the detector clamps the window glass on both sides of the window glass through the through-hole, wherein the detector biases a first surface of the window glass and a second surface of the window glass that opposes the first surface in opposite directions at positions spaced apart from the through-hole at different distances.

9. The window glass breakage detector of claim 3 wherein the contact portions of the first member with the window glass are at two positions separated from one another so that the contact portion of the second member with the window glass is located between the two positions, wherein a portion of the first member that faces the window glass including the contact portions of the first member with the window glass surrounds the contact portion of the second member with the window glass.

10. The window glass breakage detector of claim 9, wherein at least one of the first member and the second member contacts the window glass at protrusions.

11. The window glass breakage detector of claim 3, wherein at least one of the first member and the second member contacts the window glass at protrusions.

12. The window glass breakage detector of claim 4, wherein at least one of the first member and the second member contacts the window glass at protrusions.

13. The window glass breakage detector of claim 6, wherein the detector includes a biasing arm and a pair of contact portions connected to the biasing arm, wherein the pair of contact portions are biased in opposite directions from each other with respect to the surface of the window glass on one side of the window glass, and are in contact with the surface of the window glass at the offset portions on the window glass.

14. The window glass breakage detector of claim 6, wherein the window glass includes a through-hole, wherein the detector clamps the window glass on both sides of the window glass through the through-hole, wherein the detector biases a first surface of the window glass and a second surface of the window glass that opposes the first surface in opposite directions at positions spaced apart from the through-hole at different distances.
